(19) United States
(12) Patent Application Publication
(10) Pub. No.: US 2018/0179465 A1
(43) Pub. Date: Jun. 28, 2018

(54) Articles Fashioned as Candles with Integrated Health, Beauty and Well-Being Functionalities

(71) Applicants: Jill Marie Ulrich, La Jolla, CA (US); Patrizia Sophia Ulrich, La Jolla, CA (US)

(72) Inventors: Jill Marie Ulrich, La Jolla, CA (US); Patrizia Sophia Ulrich, La Jolla, CA (US)

(21) Appl. No.: 15/390,664

(22) Filed: Dec. 26, 2016

(51) Int. Cl. C11C 5/00

(52) U.S. Cl. CPC C11C 5/002; C11C 5/004; C11C 5/008

(57) ABSTRACT

Candles are provided with special purpose constituent matter to impart hell and well-being properties into the environments in which these articles are consumed. A candle is formed of combustible material, a wick element and special purpose dopants generally either transition metals or post-transition metals. Very small sized, non-ionic metal particles are held in suspension within bulk combustible material from which the candle is made. Upon burning, these small particles are lifted into the combustion reaction and propelled via vapor and smoke currents into the surrounding air wherein they are well distributed within the environment where the candle is used. So liberated from the device, these metallic particles impart health and well-being properties in a great plurality of manner in agreement with well-known biological processes.

### BACKGROUND OF THE INVENTION

### Continuing Information

This invention disclosure patent application stands on its own as an original, new and initial application for U.S. Letters Patent without continuation dependence from any earlier filed application.

### Field

The following invention disclosure is generally concerned with devices for promotion of health, beauty and well-being, devices that are arranged as candles operable for imparting biological benefit into environments in which they are deployed and consumed. More specifically candles having integrated therewith special arrangements of nanoparticles.

### Related Systems

Burning candles to bring about feelings of peace, harmony and well-being has been a very long going ritual, tradition and practice that predates even written literature. The body of documentation relating to use of candles is extensive and certainly well aged. Accordingly, no attempt is made to identify the true origins of this practice.

In earliest American traditions, a ‘smudge stick’ is a form of article for burning used to till the air with particulate of a desired nature. While not generally comprised of wax, a smudge stick is nevertheless a type of candle. Smudge sticks may be made from materials such as cedar and sage arranged to burn and produce vapor and smoke emissions therefrom, the smoke and vapor having a composition that includes matter considered beneficial as it brings about certain responses. In various rituals and ceremony smudge sticks are used in this way to purify and bless people and places. For example, according to the Tribal Directory of 2014 a Shoshone shaman in the performance of one of his three major roles is tasked with helping the sick and injured. In some applications of therapy, smudge sticks are burnt to cleanse the spirit, mind, and body. The Shoshone tribe has long been a recognized leader in these very special uses of vapor and smoke and emissions from burning article in this way to bring about health, beauty and well-being. Indeed, both inventors of this present teaching are members of the Shoshone tribe and derive in-part their skill and intuition in this area from their ancestry.

In modern day health, beauty and well-being applications, one readily finds a great plethora of treatments that may be characterized as ‘aromatherapy’. While many techniques of aromatherapy are used to release essential oils for example into the air of an enclosed environment for ingestion by occupants therein, some aromatherapy technique additionally includes use of combustion or burning of matter to create smoke having constituent beneficial matter therein. Smoke from burning sage for example has particular healing properties.

While burning material to create smoke is an important means for filling an environment (air) with important natural elements to invoke health, beauty and well-being responses to those therein, there are other highly specialized means of diffusing matter and particularly particulate matter into an air mass. In one very special case, a combustion system may be used to create means of diffusion but where the matter being diffused is strictly not a part of the combustion reaction.

For example, in U.S. Pat. No. 6,656,235 inventor An of Seoul, Korea teaches of methods of making silver-contained candle. Ionic silver in solution is integrated with a candle wick and candle bulk material. When the candle is burned, it is intended that silver ions which are not a product of combustion will nevertheless leave the candle device in the emitted fumes and be diffused into the air. Unfortunately, An's experiment did not produce a successful results and has since been abandon. A primary reason for this is that silver ions are highly reactive and quickly combine with other matter to form salts when blended with a candle fuel.

An's teaching describes in detail solutions of silver that are ‘100 parts per million and 99.99% pure’, Silver provided in solution as described by An is ionic silver well known and widely used as an antimicrobial and quite readily formed by simple electrolysis. However, once reacted with other matter the chemical properties and ability of the silver to perform as an anti-microbial agent is lost.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, Jill Marie Ulrich and her sister Patrizia Sophia Ulrich with inventions of candle systems having nanoparticles integrated therein, these nanoparticles configured and arranged to be emitted from the candle by way of a combustion reaction into a surrounding air environment. So emitted, nanoparticles in carefully prescribed configurations and arrangements operate to impart health, beauty and well-being benefits with respect to people who occupy the environments in which these candles are used.

A candle may be formed primarily of combustible matter or candle fuel such as paraffin, beeswax, palm wax, soy wax, or alternatives. In addition, additive materials such as steric acid, titanium dioxide, oils, colors, dyes, fragrances, among others known in the art may be included to bring about various nature and function to improve the performance of the candles. Depending upon choices of texture, look and feel, various portions of these ingredients may be blended together to provide for a candle bulk material or ‘fuel’.

Into a mixture of candle fuel, nanoparticles are blended to form a homogenous blend of wax, additives and nanoparticles. Nanoparticles and additives may be added to heated wax in a liquid state and then cooled to form a solid mass with a wick therein. Once appropriately cooled and hardened, these nanoparticle infused articles may be consumed in a manner similar to a conventional candle.

When candles so formed are burned, the candle fuel is consumed as a combustion reaction at the candle flame via the wick. Heated liquid fuel is drawn by the wick from a small pool and this fuel is vaporized by heat from the flame. The fuel vapor combines with oxygen in the surrounding air and is combusted in a continuous and ongoing chemical reaction. Because these devices include nanoparticles well distributed within the candle fuel, nanoparticles are also drawn up with the liquefied fuel and combined with that air fuel mixture, However, the nanoparticles do not contribute to the combustion reaction but rather are merely pushed into the strong rising fume currents that are produced by the flame. Smoke, hot air, combustion exhaust, and nanoparticles rise vigorously from the tip of the flame and are emitted into the surrounding environments. Because nanoparticles are very small in size, the fume currents operate to propel them with appreciable forces and motivate them to mix well with the surrounding air. While the nanoparticles are not part of the combustion reaction products, they do nevertheless get propelled along therewith and disbursed into the surrounding air. As such, candles of these inventions operate to dispense nanoparticles at a controlled rate and to disperse those nanoparticles into an environment.

Various important types of nanoparticles may be used to form these articles, devices and apparatus. In particular, nanoparticles characterized as particles having at least one dimension on the nanometer scale. Further, nanoparticles most suitable to impart various of desired functions include those nanoparticles having prescribed shapes and geometric arrangements. For example spherically shaped nanoparticles may impart one kind of effect while rod shaped nanoparticles bring about another effect altogether. Therefore, not only is the particle size an important consideration, but also the geometry of these nanoparticles. Still further, the composition of the nanoparticles is a very important design choice and consideration. While many preferred versions of the inventions have nanoparticles that are fundamental elements, chemical compounds are also fully anticipated. Further, some elemental versions include nanoparticles of metals, while others include metals characterized as transition metals. Still further, other alternative versions include nanoparticles of non-metal elements.

Certain alternative versions include nanoparticles comprised of complex arrangements having a core with a surface coating. These are particularly interesting in advanced biological functions such as delivering drugs into a cell. The core portion may be a metal nanoparticle while the ‘shell’ or surface coating may be comprised of matter that may be bioactive such as a drug.

Some advanced versions include candles have a composition that includes a blend of nanoparticle types of more than one discrete class. A single candle of this nature with a single flame will emit nanoparticles of a plurality of types in precisely controlled ratios. These arrangements are considered as special systems having advanced functionality.

### Objectives of these Inventions

It is a primary object of these inventions to provide candles having integrated nanoparticles.

It is an object of these inventions to provide candies operably arranged to emit nanoparticles into a surrounding environment.

It is a further object to provide systems for diffusing nanoparticles into an air environment.

It is an object of these inventions to provide candles operable for diffusing select nanoparticles into a surrounding air environment the nanoparticles being operable for imparting health, beauty and well-being benefit to humans.

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### BRIEF DESCRIPTION OF TUE DRAWING FIGURES

These and other features, aspects, and advantages of the present inventions will become better understood with regard to the following description, appended claims and drawings where:

FIG. 1 is simple illustration of one example candle article of these inventions;

FIG. 2 shows a combination of discrete candles contributing to a blended emission spectrum in a non-preferred but illustrative configuration;

FIG. 3 includes a most relevant portion of the periodic table;

FIG. 4 are photographic examples of some important examples of metallic nanoparticles; and

FIG. 5 includes three photographic images of shaped nanoparticles and hybrid nanoparticles with functional coatings.

### DETAILED DESCRIPTION AND PREFERRED EMBODIMENTS

In accordance with each of preferred embodiments of the invention, nanoparticle doped candles are provided. It will be appreciated that each of the embodiments described is directed to a particular article and that the article of one preferred embodiment may be different than the article of another embodiment. Accordingly, limitations read in one example should not be carried forward and implicitly assumed to be part of an alternative example.

Nanoparticles of various size, form and composition may exist in a suspension as a heterogeneous mixture in which the nanoparticles do not dissolve in but are suspended throughout the bulk material of the candle's combustion medium or fuel comprised of paraffin wax, beeswax, coconut wax, oils, perfumes, binders, additives, et cetera.

When a candle in these novel configurations is consumed by burning, the wick draws up liquefied fuel and nanoparticles into a combustion space (from the lower end of the flame) which combines oxygen from the surrounding environment with heated vaporized fuel to produce a combustible mixture that bums as a gentle well-regulated flame. As hot liquid wax is drawn up by the wick, it carries with it nanoparticles that have been carefully distributed throughout the bulk material in manufacture processes. These nanoparticles do not participate chemically in the combustion reaction except perhaps to absorb very small amounts of heat in thermal processes. Rather, the action of the combustion on the nanoparticles is such that it causes the nanoparticles to be propelled into the surrounding environments.

Thus the special purpose unique candles in accordance with the descriptions herefollowing operate in modes similar to a common candle with a comforting warmth and gentle flame, however while the candle is consumed by burning it emits into surrounding spaces a fine and controlled spatial distribution of nanoparticles that operate to bring about desired function and benefit. Benefits may particularly include health, beauty and well-being benefits as contact between so dispersed nanoparticles with human occupants and even non-living objects therein tend to generate these desirable reactions and effects.

When a candle is formed by molding for example, heated wax and appropriate additives are blended together to form a candle fuel in a liquid state. The liquid wax and additives may be poured into a special mold containing therein a wick generally placed on a symmetry axis of the mold. When the fuel mixture is allowed to cool, it hardens to form a solid body with the shape of the mold.

To make candles with integrated nanoparticles, one merely adds prescribed nanoparticles into the liquid mixture of candle fuel. Since added nanoparticles are generally nonionic, they are inert and do not react chemically with the candle fuel or additives but rather are merely well and homogenously distributed within the matrix of molecules that form the bulk material.

In this manner, one can form a simple candle with integrated nanoparticles. The outer appearance is imperceptibly different from a common candle found in retail shops everywhere as the nanoparticles cannot be seen and leave no visual indication of their presence. However, the performance and function of a candle having nanoparticles integrated therein is no less than remarkable. Via normal consumption of the article by burning, one causes a diffusion of nanoparticles into the surrounding environment whereby those nanoparticles may fall onto the skin of persons therein, are taken up with the breath of occupants, and still further fall onto the surfaces of objects, walls, floors and even the ceiling of rooms in which these products are used.

The presence of so distributed nanoparticles operate to bring about effects and reactions with matter to which they come into contact. For example, nanoparticles of carbon having a geometric structure described as a lattice in the form a diamond crystal may form a coating on walls that brings about a harmony to a room. Crystals are considered by many to impart energy channeling effects that operate to constructively improve the well-being of those in these energy fields. Energy fields that arise from a very large number of diamond crystals uniformly distributed about the surfaces of a room are very highly unique and heretofore impossible to achieve without the devices first taught and presented in detail herein. It is without doubt that such physical arrangements of crystals in this form are not realizable by alternative means without use of the articles described in this invention disclosure.

Some versions of these candles having nanoparticles integrated therein bring about effects related to beauty, Because persons sitting in a room with a burning candle in accordance with this presentation are subject to surface exposure of nanoparticles that naturally fall onto one's skin, a fine application of nanoparticles to the skin can be used to impart a beauty treatment that improves appearance of the skin. For example, anti-aging and skin moisturizing effects may be realized when nanoparticles of a specified type are reactive with the skin surface in a manner to cause it to uptake moisture. Nanoparticle exposure in this fashion, that is at the surface of the skin, can promote improvements in beauty to persons merely by sharing the space with a burning candle of these types.

In some cases, nanoparticles diffused by these candles are taken in by one's breath and arrive internally where they may bring about effects related to health. For example, under certain conditions, copper nanoparticles of particular sizes and geometric configurations have been shown to yield anti-bacterial, antimicrobial, and other beneficial biological activity. When carefully arranged, gold nanoparticles are believed to bring about a specific cytotoxicity that operates to selectively kill cancer cells. Thus, consumers of these candles appropriately designed with the correct dose and arrangement of gold nanoparticle contents may in fact be beneficiaries with respect to health by merely breathing in these nanoparticles that operate to kill certain cancers.

A considerably long list of additional nanoparticle types and corresponding biological effects is comprehensively long indeed. It does nothing to improve the understanding of this teaching to attempt to catalogue these exhaustively. Rather, it is sufficient to note the considerable motivation to distribute nanoparticles as described without setting forth all the possible benefits that may be achieved via use of such devices.

From an outer appearance, nanoparticle candles in accordance with the invention appear quite identical to candles long used and ubiquitously found. For example a cylindrically symmetric body with circular cross section including a wick disposed on the symmetry axis. This configuration assures good coupling between the candle fuel and the combustion space whereby hot liquid fuel is readily draw up by the wick and pulled into a burning flame. Because nanoparticles are very small and have very little mass, they are necessarily drawn with the fuel. Once the fuel vaporizes and burns, it produces hot gas exhaust and the nanoparticles are further drawn thereinto these hot currents. Because the fume currents are quite hot after combustion, they rise with some vigor away from the flame and candle. These currents further carry the nanoparticles away from the candle device and they are well-distributed about the immediate environment.

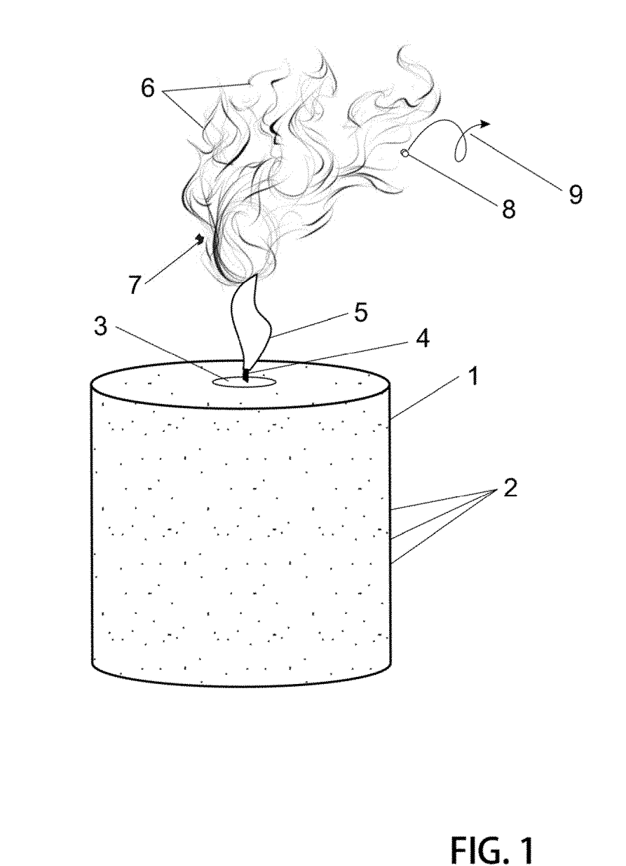

With reference to FIG. 1, a candle main body 1 is formed of hardened wax or fuel in a bulk material having variable composition for example with blended additives to improve performance characteristics. In addition to conventional additives, the bulk material from which the candle is made further includes nanoparticles 2 uniformly distributed and held in suspension within the matter from which the candle body is made. These may he added to the wax when it is melted or in a liquid state. The liquid wax plus additives may then be introduced to a mold and cooled whereby the wax hardens and holds the nanoparticles in a well-distributed uniform suspension. The nanoparticles do not migrate about the bulk material and are held fixed in position. Further, they do not interact chemically with the bulk material. Still further, when these nanoparticles are drawn up into the combustion space and candle flame, they do not ‘burn’ nor chemically react with any of the combustion products. Rather they are simply left without chemical change and propelled from the flame and pushed into the surrounding air with appreciable force.

When the candle burns, a liquid pool of melted fuel 3 forms near the tip of the junction where wick 4 extends from the top of the candle. A flame 5 stays continuously lit as combustion takes place and the candle is slowly consumed. Strong exhaust currents emanate from the flame and tend to rise upwardly. These exhaust currents carry particulate matter 7 that can be quite large in size comparatively with respect to the nanoparticles and this particulate is a byproduct of the combustion, These particles may be simple amorphous carbon formed as ‘soot’ for example and are quite harmless in most instances. Special nanoparticles 8 are additionally launched into the air currents thus emitted by way of the combustion action. Because they are quite light and tiny they readily move about in air currents 9 and may stay aloft for a considerable time before submitting Ultimately to the forces of gravity and finally falling downwardly,

### Special Combinations

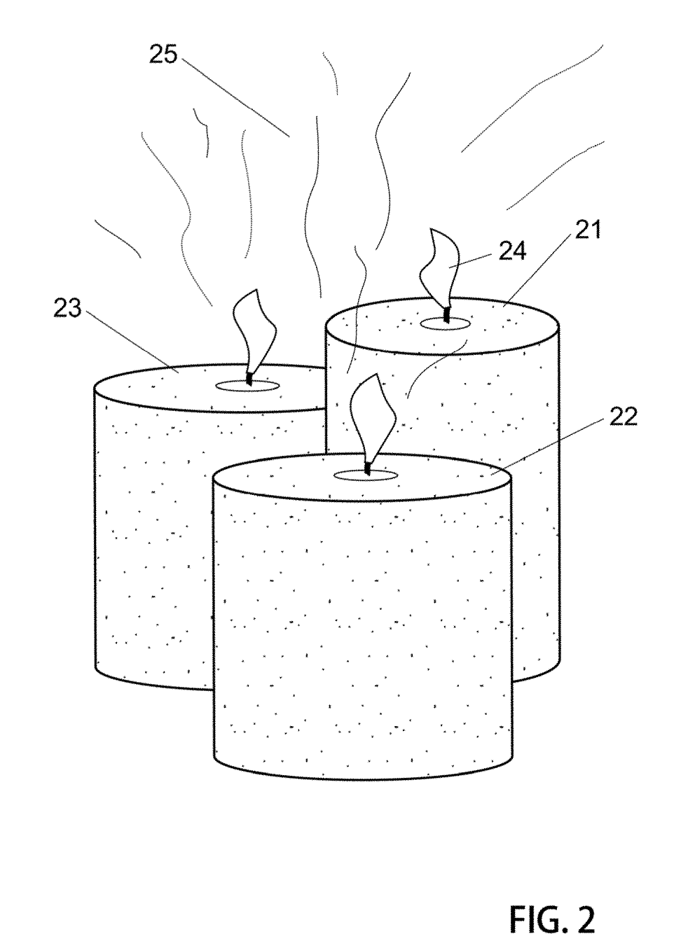

With reference to FIG. 2. which illustrates a plurality of discrete candles burning simultaneously to form an amalgam emission of vapor and particulate matter. A first candle 21 may be one prepared with a dopant of copper nanoparticles for example. A second separate candle 22 may have uniformly distributed therein the bulk material a gold nanoparticle dopant. A third candle 23 may be arranged with a third dopant type characterize as comprising silver nanoparticles. When these three candles are burning together, they operate in conjunction with each other to emit a harmonious combination of nanoparticles into the surrounding environments. The flame 24 causes copper nanoparticles to be emitted into the vapor mixture where these are joined by similar nanoparticles of both gold and silver, These are quickly mixed into a uniform vapor cloud and dispersed into naturally occurring air currents due to thermal effects.

Because it is difficult for users to control the ratios of these nanoparticle mixtures by lighting several candles together, some preferred versions of these inventions anticipate single candle articles ‘tuned’ to specific objectives and performance that might be realized by prescribed combinations and/or ratios of nanoparticle types mixed together in the single device.

In one very important version of these systems, a single candle is provided with two types of nanoparticles from a set of desired metals. Specifically, such candles comprise at least two discrete elements each of which is a member from the 4^{th} through 6^{th} periods and 10^{th} through 13^{th} groups of the periodic table. In other words, a candle is doped with two types of nanoparticles each from the group comprising: boron, aluminum, nickel, copper, zinc, gallium, palladium, silver, cadmium, indium, platinum, gold, mercury, and thallium. While these nanoparticles exist as elemental matter not formed as chemically bonded compounds, the particles are nevertheless mixed together into a uniform suspension of matter and combined with common candle bulk material formations to arrive at a device that emits these nanoparticles into the environment at prescribed desired ratios with excellent precision.

### Harmonious Blends

Because some best uses of these systems demand specific combinations of nanoparticle elements in prescribed proportions, special versions of articles of singular unit include a plurality of nanoparticle constituents. That is, a single candle may be formed with nanoparticles distributed uniformly throughout its fuel matrix whereby said nanoparticles is a blend of two or more elements in a ratio designed to impart a desired effect.

In a first basic illustrative example, a candle may be formed of a soy wax fuel having mixed therein a 1:5 ratio of gold nanoparticles to copper nanoparticles. While an environment can be suitably energized by way of burning a plurality of candles each having but one nanoparticle type, such strategy is less than convenient to deploy as burning 1 gold containing candle along with 5 copper containing candles to achieve the desired blend is cumbersome and tedious. Further, because the flames are not easy to control with regard to uniformity, there is a distinct probability that the resulting ratio would not actually be 1:5 but rather something slightly different than that. Where a single device is prepared with the preferred blend of gold and copper nanoparticles 1:5 that can be very precisely arranged during candle manufacture, burning such a candle with a single flame assures a perfect ratio of these nanoparticle types.

### Health Benefits

Nanoparticles of various elements and compounds have been demonstrated to have otherwise unexpected interactions with biomatter. These interactions are not similar to comparatively large size particles (i.e. greater than about 1500 nanometers) of the same composition. Nanoparticles give rise to new and useful interactions and often these interactions and their efficacies are dependent upon the precise size and configuration of the nanoparticles. Indeed, nanotechnology is an important field of science getting a great deal of attention this even date.

In particular, it has recently been discovered that simple single element nanoparticles can yield unexpected reactions and behaviors with biological matter such as microorganisms, viruses, microbes, bacteria, among others. Elements such as copper, gold and silver when formed as specially configured nanoparticles for example have been shown to lyse cell membranes of various types of microbes causing their destruction.

Gold nanoparticles have very unique physicochemical properties and in recent studies this has been shown to be quite important with regard to the results that may be achieved. They have the capability of easy functionalization; binding to amine and thiol groups for example. All these characteristics possessed by gold nanoparticles pave the way for surface modification, and are being investigated as drug carriers in cancer therapy. Gold nanoparticles are considered to be relatively safe, as its core is inert and non-toxic. In one experimental study, several gold nanoparticles of 4 nm, 12 nm, and 18 nm with different capping agents have been investigated for any cytotoxicity against leukemia cells. The results of this report suggest that spherical gold nanoparticles enter the cell and are non-toxic to cellular function. The cytotoxicity was evaluated by MTT assay. However, there are additional reports suggesting that cytotoxicity associated with gold nanoparticles depends on dose, side chain (cationic) and the stabilizers used. Cytotoxicity of gold nanoparticles are dependent on the type of toxicity assay, cell line, and physical/chemical properties. The variation in toxicity with respect to different cell lines has been observed in human lung and liver cancer cell line.

Nanoparticles of various size, form and composition have been shown to effect an antibiotic, antimicrobial and anti-fungal functionalities. The body of research showing these wonderful properties is just recently exploding as nanoparticle research is very much an emerging discipline, it is expected that each day will bring new clues as to which nanoparticle forms and compositions will impart which effects. Where such effects are compatible with use of candles in an enclosed space, these inventions provide excellent means of nanoparticle emission.

Because of their small size, nanoparticles find their way easily to enter the human body and cross the various biological barriers and may reach most organs without difficulty. Scientists have proposed that nanoparticles of size less than 10 nm act similar to a gas and can enter human tissues easily and may operate to effect cells to bring about a desirable action or function.

### Burn Emission Rates/Dosing

Systems taught herein are very amenable to precise control of nanoparticle emission rate or density. In applications where the density of nanoparticle emission is an important consideration, designs of nanoparticle doped candles in support of a particular rate are readily made to bring forth desired effects. For example, if it is determined that a room is most beneficially advantaged by a density of gold particle emission at a rate of 150 million particles per hour, candles may be doped with a particular concentration in view of the candle burn rate and capacity. A candle with a quantity of fuel sufficient for a total of 10 hour burn time would therefore require a total of 1.5×10⁹ particles blended into the fuel bulk material. When such candle is burned, the consumption of fuel is predictable and assures a nanoparticle emission rate of 150 million particles per hour While not perfectly consistent from candle to candle, the candle burn rate nevertheless assures a very good dosing scheme that provides for a prescribed concentration of nanoparticle emission.

### Elements/Compounds

While many of the best versions anticipated include elemental nanoparticles, these inventions are certainly not limited to nanoparticles comprised of a fundamental element but rather nanoparticles formed from a chemical compound having a plurality of bond elements are fully anticipated. Because nanoparticles in some definitions are classified as objects having as one dimension a linear measure of between about 1 nm and 300 nm, many chemical compounds make excellent discrete small particle objects. While a considerable portion of this disclosure is directed to nanoparticles formed from an element, the disclosure is most certainly not to be considered limited thereto. Indeed, the inventors fully understand the great potential to realize new and important functions which can only be achieved by particles of very small size where those particles are comprised of chemical compounds. Candles doped with nanoparticle constructs from chemical compounds will perform wonderfully as diffusers of said chemical compound nanoparticles so long as the heat of the combustion at the candle flame does not operate to break the chemical bond and damage the compound.

In some important alternative versions, a nanoparticle comprised of a chemical compound is used to dope the bulk fuel of a candle. When burned, these special nanoparticles are expected to be modified by the heat of the flame and to produce new nanoparticle compounds and/or elements. In these cases, the resultant emissions are provided with the objective to bring about a corresponding effect. Thus, some special versions anticipate a chemical modification to the nanoparticle as it transits from the bulk fuel to a free floating particle the modification being driven by the candle heat.

### Preferred Elements

While nanoparticles suitable for use as dopants in candle fuel to promote emission and diffusion of said nanoparticles may be formed from a great plurality of chemical elements and even non-elements compounds, there are some very particularly important chemical elements that have immediate benefit known to experts. These emerging uses are being studied with vigor and more each day come into the body of science. Accordingly, while the best examples that illustrate most preferred uses and best modes include some particular elements, the invention is certainly not to be limited to those particular elements. It is well and fully anticipated that chemical elements not explicitly set forth in detail herein will nevertheless also serve to promote great benefits in alternative versions of these devices. As such, the invention should be limited by the appended claims rather than by the various examples set forth herein. While the best modes are presented, it is impossible to include all possible versions of nanoparticle compositions and configurations.

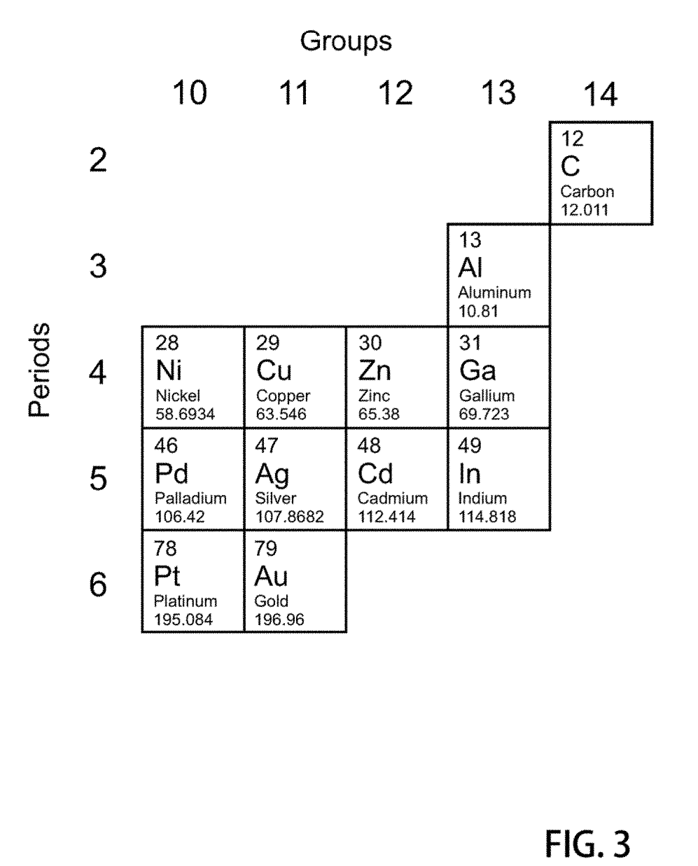

Nevertheless, FIG. 3 is directed to a portion of the periodic table that includes those elements found to be most beneficial and having the greatest likelyhood to yield desirable effect. Specifically, metals, transition metals, post transition metals, and non-metal (carbon) belonging to periods 2-6 and groups 10-14 have been found to be quite useful in some versions of these articles. Specifically elements including: carbon 12, aluminum 13, nickel 28, copper 29, zinc 30, gallium 31, palladium 46, silver 47, cadmium 48, indium 49, platinum 78 and gold 79, have been found to form useful nanoparticle types that may be blended into the fuel from which a candle is made. Upon burning of same candle, these nanoparticles are emitted and diffused about the air of a space in which the candle is used.

Particularly attractive results have been found for both gold and diamond (carbon). Gold is very non-toxic in most all forms, is easy to form into useful sizes with modest synthesis processes and is readily available in quantities operable for the arrangements described herein. Although gold is the most expensive of the elements used, it remains nevertheless economically attractive because the quantity by weight of gold necessary to manufacture an effective candle of these systems remains reasonable.

Gold nanoparticles are readily formed with very good precision in many shapes and sizes. For example, in a paper published in conjunction with NanoCon 2015, Oct. 14-16, 2015 titled: ‘Synthesis of gold nanoparticles via chemical reduction methods’, authors Zhao et al, present advanced technique to form gold nanoparticles with desired characteristics.

Similarly, diamonds are extremely expensive only when in a form suitable for making gem quality jewelry. When diamonds are formed as nanoparticles, they are quite inexpensive to produce. Specifically, diamond nanoparticles may be produced in a detonation process that yields a considerable quantity of very small diamond crystals. These are readily filtered to assure a size or size range consistent with specified objectives.

### Metals and Transition Metals

Many of the preferred arrangements of nanoparticles in conjunction with candles include those where a metallic element is blended with the bulk fuel material from which a candle is made. More particularly, various important transition metals and post transition metals are sometimes preferred. For example transition metals from groups 10 through 12 are preferred with the transition metals of group 11 having particular importance. Transition metals of group 11 provide a foundation from which many versions of some best performing articles are made. Copper, gold and silver nanoparticles have each been extensively studied with particular regard to their interactions with biological systems. More each day, the nanotechnology science community develops information as to how certain sizes, arrangements and densities of nanoparticles might be deployed to cause health, beauty and other well-being effects.

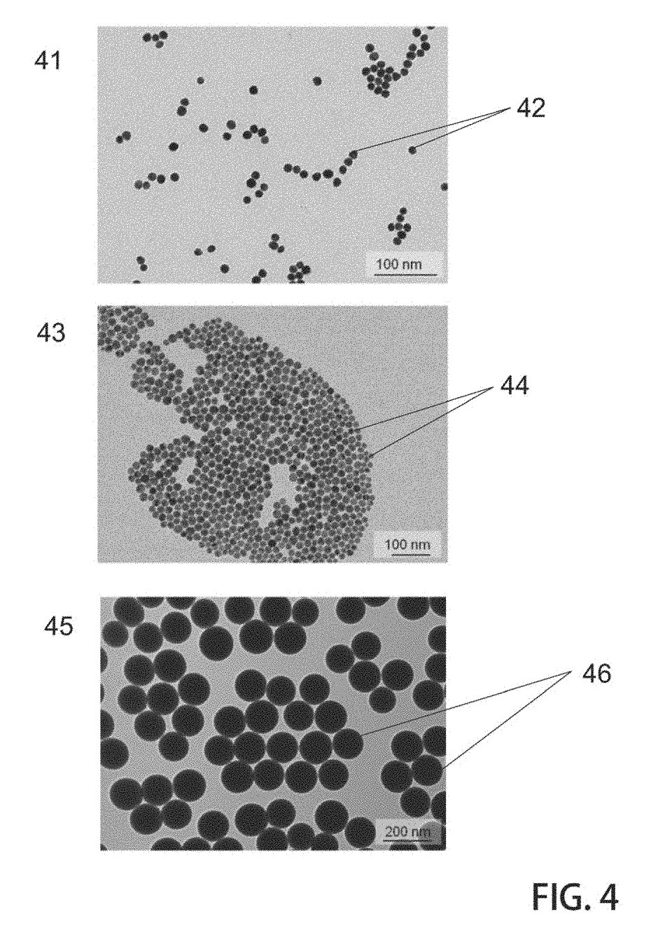

FIG. 4 illustrates in special highly magnified photographic images some important metal nanoparticles. For example the photograph 41 shows one important configuration of metal nanoparticle. Gold formed in 15 nanometer diameter spheres are readily integrated with a candle fuel. These particles are electrically neutral and do not form chemical bonds with any matter from which the candle bulk material is comprised. Rather, the particles exist in suspension and are uniformly distributed. The photographic image 43 shows another metal nanoparticle sample. Silver nanoparticles of similar size are also of significant interest for combination with a candle. These particles are readily formed as having a diameter of between about 20 and 25 nm.

### Post Transition Metals

In some versions, post transition metals from group 13 may be used as a dopant the bulk material fuel of a candle in agreement with this teaching. Aluminum for example is an element that has been shown to operate in a manner that brings about desired biological effects among others. Aluminum is a particularly available material and is readily amenable to processes that can be used to form aluminum in nanoparticles of a wide range of preferred sizes and shapes with precision as it is chemically not complex to manipulate. Various aluminum nanoparticle arrangements may each impart a different desired effect.

For example, aluminum oxide nanoparticles have been shown to invoke an antimicrobial activity in a paper published as titled: “Antimicrobial activity of aluminum oxide nanoparticles for potential clinical applications”, Formatex 2011.

In another very important application that becomes far more important with each passing day relates to drug resistant bacteria. As so called superbugs become more dangerous with the decaying efficacy of antibacterial drugs, new approaches must be found. In studies detailed in World journal of Microbiology and Biotechnology, 2015 January, authors Ansari et al present “Green synthesis of Al₂O₃ nanoparticles and their bactericidal potential against clinical isolates of multi-drug resistant Pseudomonas aeruginosa”. This study suggest that nanoparticle approaches to may soon become a preferred choice with respect to highly dangerous drug resistant bugs.

Still further, antifungal action has also been observed with regard to certain versions of aluminum oxide nanoparticles. “Green synthesis and antifungal activity of Al₂O₃ NPs against fluconazole-resistant Candida isolated from a tertiary care hospital” in RSC Advances 11 Nov. 2016. Having a candle that emits antifungal nanoparticles will improve the health and livability of an environment in which these candles are consumed.

Because aluminum oxide is a very durable molecule it can withstand the brief time that it is exposed to the heat of a candle flame without appreciable change. Therefore, aluminum oxide nanoparticles are very compatible with integration as described herein. Thus, post-transition metals are included here for some versions of these articles.

### Non-Metals

One most important version of candles containing nanoparticles therein includes nanoparticles from a non-metal element. Specifically, carbon is an example of a non-metal element that nevertheless is quite useful in some nanoparticle configurations. From an application point of view, the carbon-based nanomaterials, such as carbon nanotubes, fullerenes, single and multi-walled carbon nanotubes are a most attractive and widely used type of nanoparticle. Carbon-based nanoparticles have been reported in literature as cytotoxic agents. For example, these have been studied for use in attacking diseased cells such as cancer cells.

### Diamond

More particularly, carbon in one of its alternative solid states characterized as diamond. Diamond nanoparticles of particular preferred structure may be formed and blended uniformly with the fuel from which a candle is formed. Upon burning of such candle, the action of drawing heated fuel up into a combustion space includes drawing therewith these diamond nanoparticles. The diamond is not ‘burned’ nor is a participant in any discernable way with the combustion reaction, but rather is drawn from its resting state as homogenous particle distribution in a candle fuel and emitted as tiny free floating particles in air currents that are produced by the combustion reaction. So emitted, these diamond nanoparticles are thereafter well dispersed into the environment surrounding the burning candle.

While carbon is a nonmetal element, and the only example non-metal nanoparticle dopant element included as a member of this teaching, it does nevertheless belong as carbon in various forms does impart desirable characteristics with respect to health, beauty and well-being.

### Chemical Compounds

While a great many of the applications anticipated herein include those applications where nanoparticles are made from more fundamental elements, nothing excludes the possibility of nanoparticles comprising a plurality of elements joined via covalent bonds. Indeed, it is strictly to be includes as a version of these system where a nanoparticle is formed of a chemical compound and combined with bulk fuel for candles such as wax as a heterogeneous distribution or mixture.

The photographic image 45 shows a special nanoparticle configuration having a size of approximately 100 nm. Further, these particles are formed of a chemical compound known a silicon dioxide or SiO₂. Silicon dioxide is a durable molecule and thus is suitable for combination with these devices which use the flame of a candle to disburse nanoparticles are a very controlled rate.

Iron Oxide nanopowders are sometimes used in the detoxification of biological fluids. Fe₃O₄ of high purity may be formed as nanoparticles between 15 and 20 nanometers. These nanoparticles are an example of a chemical compound suitable for use with candles that operate to diffuse these compound particles into an air environment.

### Hybrids

Some nanoparticles are not strictly either an element or compound but rather are formed in two portions where one portion is an element and a second portion is a compound. This is particularly illustrated with gold nanoparticles as a gold sphere makes an excellent host to attach organic matter thereto. In a nanoparticle hybrid configuration, the core may be operable for carrying the organic matter to a specific place such as to a specific cell type (i.e. cancer cell) or even into the center of a cell through its outer membrane.

### Functional Coatings

Coatings for example may be formed in some versions of these devices whereby the coating has some functional nature. For example, coatings may include polymer layers such as polyethylene glycol (PEG) or silica. In cases where the heat of combustion at the candle flame is not prohibitive with regard to damaging a coating, nanoparticles with functionalized coatings may be diffused into an environment by these systems.

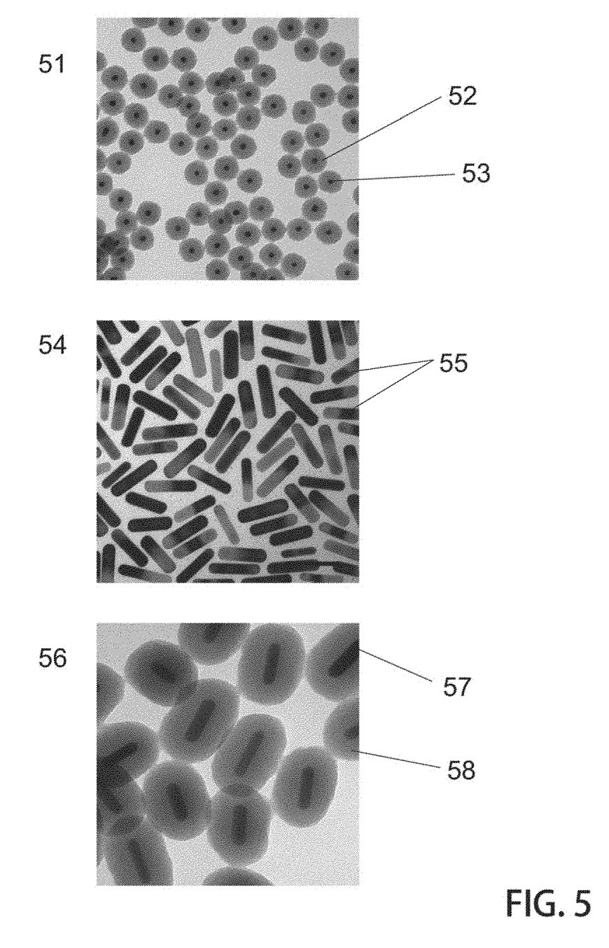

FIG. 5 illustrates in three photographic images some important example versions of nanoparticles having special arrangements including sonic functionalized coatings compatible with these inventions. The image 51 shows silica coated gold sphere nanoparticles. With the coating included, the diameter of such particles may be as small as 20 nanometers, in such versions, a 5 nm core of gold sphere is provided with the shell or outer coating of silica comprising the remainder of the system to form a ‘hybrid nanoparticle’ of specific design.

Image 54 shows gold nanoparticles formed as a rod shaped particles 55. The particle has a circular cross sections and is elongated in one linear dimension. A gold rod nanoparticle may be formed for example as a 10 nm (diameter) by 50 nm (length) configuration.

An image showing a combination of a shaped nanoparticle with a functional surface is presented as image 56. A gold rod nanoparticle has a silica surface coating. Specifically, a gold rod 57 approximately 50 nm in length includes a silica coating 58 that may be about 20 nanometers in thickness.

### Drugs

Some special versions nanoparticles that may be used in alternative embodiments of these systems include drugs attached to a particle core. In some excellent applications of the systems first introduced in this teaching, an article that is a nanoparticle doped candle may operate to dispense drugs into the air whereby they may be ingested via aspiration. Nanoparticles in some configurations have been found to operate as a vehicle to deliver drugs because they exhibit unusual behavior that sometimes preferentially aids in producing a biological response. Where that response can be combined with attached chemistry arranged as a drug, an advanced drug delivery scheme may be realized.

### Nanoparticle Configuration

### Nanoparticle Size

Researchers have reported that carbon-based nanoparticles possess size-dependent cytotoxicity. That is, when forming nanoparticles with a particular objective in mind, it is sometimes useful to select various sizes of nanoparticles to increase the efficacy of that objective. Accordingly, variations in particle size have been shown to be preferentially operative with regard to certain effects.

Strictly speaking for purposes of this disclosure the term nanoparticles is intended to include particles between about 0.5 nm to 1500 nm. While most preferred versions of candles having nanoparticles therein will include nanoparticles of the types between about 1 nm. and 300 nm, it is still an important consideration that some ‘nanoparticle’ configurations are quite large and indeed exceed the traditional definition of nanoparticle. For purposes of this disclosure, in some cases a particle as large as 1.5 microns is still to be considered a ‘nanoparticle’ suitable for integration with a candle.

### Nanoparticle Configurations

Investigators have further tested various forms of carbon based nanoparticles on lung cancer cells to assess cell viability with MTT assay. Results in this regard have been published by some important studies on carbon nanomaterials. Investigators have used a different approach for the evaluation of cell toxicity by using the clonogenic assay technique for cell proliferation and cell death. They utilized human alveolar carcinoma epithelial cell line, normal human bronchial epithelial cell line, and human keratinocytes cell line. For example, in sonic of these efforts, it was found that carbon nanotubes exert size-dependent toxicity. Multi-walled carbon nanotubes have produced certain negative effect, as compared to single-walled carbon nanotubes, which were readily taken up by macrophages cells usually present at the site of an infection.

Thus, it is fully anticipated in some versions of articles of these inventions that nanoparticle includes nanoparticle of a prescribed shape and configuration like lattices, nanotubes, rods, fullerenes, cubics, spheres, et cetera.

### Synthesis of Nanoparticles

While nanoparticles sometimes exist in nature without any affirmative actions to bring them into existence, generally speaking for articles presented herein it is necessary to generate these nanoparticles chemically. Most versions of these candles haying integrated nanoparticles therein contain nanoparticles of a specified type and class, the nanoparticles in nature are quite difficult to use to satisfy the design criteria. For example, if a specific candle design requires spherically shaped gold nanoparticles between 3 nm and 5 nm in a density of 1 million particles per gram of candle fuel, these particles may be difficult or impossible to find in sufficient quantity in any natural occurrence where gold nanoparticle may be found. Thus it becomes necessary to synthesize them whereby a sufficient quantity, of regularly shaped particles, of a prescribed size range, is easily obtained. While it is not impossible to make candle designs that only use nanoparticles found in nature, many preferred versions require chemical synthesis of desired nanoparticles.

### Synthesizing Copper Nanoparticles

Copper nanoparticles can be manufactured using numerous methods. The electrodeposition method is considered by many as one of the most suitable and easiest. The electrolyte used for the process is an acidified aqueous solution. of copper sulfate with specific additives.

A spongy layer of copper particles is deposited on the cathode surface when the input DC voltage is varied with a constant current. The particles are typically characterized and assessed by XRD and UV-Vis. The surface morphological characterization is done using scanning electron microscopy (SEM) and transmission electron microscopy (TEM).

Damp reunion tends to affect the dispersion. performance and usable properties of copper nanoparticles; hence this material has to be sealed under vacuum and stored in a cool and dry room. It should not be exposed to air, and should not be under stress.

### One Specific Example Copper Nanoparticle Synthesis Method

Although, the following example method can be used to prepare number of different types of nanoparticles including, gold, silver and nickel, this discussion is directed to the synthesis of copper nanoparticles.

Copper nanoparticles are characterized as having high surface to volume ratio. They have been shown to display useful properties like antibacterial and fungicidal activity. Copper nanoparticles and metal oxide nanoparticles of copper have widespread commercial presence, especially as fungicides. Copper fungicides are extremely effective against certain species of fungi that are common agricultural pathogens. Copper nanoparticles show excellent antimicrobial property against many pathogenic microbes and may be used as a commercial antimicrobial agent.

Using electrochemical synthesis, copper nanoparticles may be readily prepared. Usually, copper nanoparticles are not stable and will slowly oxidize to copper oxide nanoparticles. Liquid copper nanoparticle dispersion can have the appearance of beautiful golden yellow color and will slowly turn to reddish black color as it oxidizes to metal oxide nanoparticles of copper. To synthesize copper nanoparticles the following are needed:

1. copper bulk material such as rods or sheets;

2. A DC power supply;

3. convenient electrical connectors such as ‘crocodile clips’;

4. 250 ml of distilled water;

5. A beaker or glass cup for hot water;

6. Means to stir the water

7. Ascorbic acid 1.0 grams (for example 50 mg of Vitamin C)

8. Chitosan 0.1 gram (optional)

### Preparation

Step 1: Add water to the glass beaker and bring it to boil. Then take the heat away and add ascorbic acid (e.g. vitamin C pills) and chitosan (optional) and stir until they dissolve completely.

Step 2: Setup electrodes and spacer and connect them to the positive and negative wires of the DC power supply.

Step 3: Turn on the power supply and set the voltage to a value between 6-12 V while the solution is still hot. Small bubbles may be observed appearing from the cathode (the copper rod connected to the negative wire of the power supply.)

Step 4: Stir the solution. Solution will slowly turn to light yellow color which develops in to a beautiful golden yellow color with slight reddish tint.

Turn off the power supply.

Step 5: A liquid copper dispersion having diameter in submicron range.

### How Copper Nanoparticles Form

In acidic conditions, copper metal (Cu) in the anode (copper rod attached to the positive wire of the power supply) oxidizes to form copper ions Cu⁺². These copper ions are released to the solution and will slowly travel towards the cathode. At the cathode, these copper ions will gain electrons and reduces back to copper metal, leaving a metal deposit on the cathode side. This is the main concept behind, electrodeposition.

The ascorbic acid operates as a. reducing agent in the solution. Heating the mixture encourages chemical reactions to proceed more quickly.

Ascorbic acid, will not only function as a reducing agent but also as a capping agent. When small copper particles are formed, ascorbic acid molecules will cap or surround the particle making it difficult for similar copper particles to attach to each other. This prevents the uncontrolled growth of the particles to micron sized dimensions.

Synthesis of Diamond Nanoparticles

Detonation nanodiamond, also sometimes known as ultradispersed diamond, is diamond that originates from detonation. When an oxygen-deficient explosive mixture of TNT or RDX is detonated in a closed chamber, diamond particles with a diameter of 5 nm are formed at the front of the detonation wave.

Diamond nanocrystals of approximately 5 nm in diameter can be formed by detonating certain carbon-containing explosives in a metal chamber. During the explosion, the pressure and temperature in the chamber become high enough to convert carbon from the explosives into very small diamond crystals. Being immersed in water, the chamber cools rapidly after the explosion, suppressing conversion of newly produced diamond into more stable graphite.

In a variation of this technique, a metal tube filled with graphite powder is placed in the detonation chamber. The explosion heats and compresses the graphite to an extent sufficient for its conversion into diamond. The product is always rich in graphite and other non-diamond carbon forms and requires prolonged boiling in hot nitric acid about 1 day at 250° C. to dissolve them. Recovered nanodiamond powder is used primarily in polishing applications.

Diamond nanocrystals can also be synthesized from a suspension of graphite in organic liquid at atmospheric pressure and room temperature using ultrasonic cavitation. The yield is approximately 10%. The cost of nanodiamonds produced by this method are estimated to be competitive with the HPHT process.

An alternative synthesis technique is irradiation of graphite by high-energy laser pulses. The structure and particle size of the obtained diamond is rather similar to that obtained in explosion. In particular, many particles exhibit multiple twinning. Recently Mohan Sankaran and Ajay Kumar from Case Western Reserve University achieve the fabrication of nanodiamonds 2-5 nm in size at near-ambient conditions by a microplasma process. The nanodiamonds are formed directly from a gas and require no surface to grow on.

### Synthesis of Silver Nanoparticles

The formation of silver nanoparticles can be observed by a change in color since small nanoparticles of silver are yellow. A layer of absorbed borohydride anions on the surface of the nanoparticles keep the nanoparticles separated. When sodium chloride NaCl is added the nanoparticles aggregate and the suspension turns cloudy gray. The addition of a small amount of polyvinyl pyrrolidone will prevent aggregation.

About 30 mL of 0.002M sodium borohydride (NaBH4) is added to an Erlenmeyer flask or other suitable vessel. The solution is preferably made fresh right before the performing this process. A magnetic stir bar is placed in the flask and the flask placed in an ice bath on a stir plate. The solution is then stirred. The sodium borohydride (NaBH4) kept on ice will reduce the rate of decomposition during the process.

2 mL of 0.001M silver nitrate (AgNO3) in then dripped into the stirring NaBH4 solution at approximately 1 drop per second. Stirring is stopped as soon as all of the AgNO3 is added.

The presence of a colloidal suspension can be detected by the reflection of a laser beam from the particles.

A small portion of the solution is transferred to a test tube. A few drops of 1.5 M sodium chloride (NaCl) solution is added to cause the suspension to turn darker yellow, then way as the nanoparticles aggregate.

A small portion of the solution is transferred to a test tube. Add a drop of 0.3% polyvinyl pyrrolidone (PVP). PVP prevents aggregation or ‘clumping’ of the particles. Addition of NaCl solution then has no effect on the color of the suspension.

Enough solid polyvinyl alcohol (PVA) is added to yield a 4% solution. To get the PVA to dissolve, SLOWLY add it to the stirred, hot, silver colloid solution.

Decant the mixture into a mold leaving air bubbles and undissolved PVA in the beaker.

In a final step, liquid is removed by evaporation in an oven for 30 minutes. Alternatively the solution can be left in a hood over two days to evaporate.

### Synthesis of Aluminum Nanoparticles

A synthetic route has been described for the production of aluminium nanoparticles. These aluminium nanoparticles were obtained through a reduction of aluminium acetylacetonate [Al(acac)₃] by lithium aluminium hydride (LiAlH₄) in mestitylene at 165° C. The side products are removed by repeated washing with dry, ice cold methanol and the reaction mixture filtered to obtain gray-colored aluminium nanoparticles. The synthesized nanoparticles may be characterized by powder X-ray diffraction pattern and Al-MAS-NMR spectrum. The X-ray diffraction pattern confirms the formation of face-centered cubic form of aluminium. The size and morphology are investigated by scanning electron microscope and transmission electron microscope which yields particles of varying shapes with size ranging from 50 to 250 nm. The weight loss from the nanoparticles may be examined by thermo gravimetric analysis which indicated that the nanoparticles were tightly bound with an amorphous organic residue which cannot be removed by simple washing. Further detail may be examined with reference to “Chemical Synthesis of Aluminum Nanoparticles” journal of nanoparticle research June 2013.

### Combinations of Engineered Nanoparticles and Natural Nanoparticles

Nanoparticles may occur naturally and these naturally occurring nanoparticles may be collected and used as dopant in the manufacture of candles for special purpose uses in accordance with the teachings presented herein throughout. Naturally occurring nanoparticles may be purified and filtered for preferred characteristics such as size, shape, composition, et cetera. These may be carefully measured for quantity and mixed with a bulk material fuel and wick to form a system having ability to bring about a desired effect on an environment in which the candle may be consumed.

Blends of nanoparticles both naturally occurring and synthesized may also be used to create most useful dopants for candles in agreement with the objectives and teachings suggested herein.

As is quite clear from the disclosure above, the precise nature and arrangement of nanoparticle may be highly variable to produces certain desired effects. It is impossible to exhaustively list all combinations. Rather, sonic clear examples have been presented herein to illustrate the broad scope of the various versions of this invention. Therefore, it is the combination of using the combustion action of a candle to provide means for diffusion nanoparticles into an environment that is the essence of the inventive articles. These highly unique systems should not be limited to any particular nanoparticle size or configuration, but rather the entire collection of species that fall under the definitions set for in the appended claims,

One will now fully appreciate how the arrangements first described herein provide for new, useful and innovative articles and compositions that may be consumed to improve the health and well-being of environments in which they are used. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

We do hereby claim the following as our invention:

1) Articles arranged as candies comprising nanoparticles.

2) Articles of claim 1, said candles are comprised of a bulk material fuel, and a wick, said nanoparticles are well distributed within said bulk material fuel.

3) Articles of claim 2, said nanoparticles are particles greater than about 1 nanometer on any dimension and less than about 300 nanometers on any dimension, the nanoparticles being homogenously distributed throughout said bulk material fuel material.

4) Articles of claim 2, said nanoparticles are uniformly distributed within said bulk material fuel to form an homogenous suspension.

5) Articles of claim 2, the ratio of said nanoparticles with respect to bulk material fuel exceeds 1 million particles per gram of fuel.

6) Articles of claim 2, said nanoparticles are elemental particles.

7) Articles of claim 2, said nanoparticles are elemental particles.

7) Articles of claim 7, said nanoparticles are either from the group including: transition metals, post transition metals, non-metals.

9) Articles of claim 7, said nanoparticles are from the 2^{nd} through 6^{th} periods and 10^{th} through 14^{th} groups of the periodic table.

10) Articles of claim 2, said nanoparticles are a chemical compound comprising a plurality of elements.

11) Articles of claim 2, said nanoparticles are hybrid particles having a core portion and a surface portion, wherein the core portion and the surface portion are either elemental or compounds.

12) Articles of claim 2, said nanoparticles are formed of a shape having a symmetric geometry.

13) Articles of claim 12, said nanoparticles shapes are either from the group including: spherical, cylindrical, fullerene, bi-layer fullerene crystalline, lattice, and tube.

14) Articles of claim 11, said surface portion is a drug.

15) Articles of claim 4, said candle comprises a blend of at least two discrete nanoparticle types.

16) Articles of claim 15, said blend is a concentration ratio between said two discrete types whereby the ratio is an integer.

17) Articles of claim 15, the concentration of each of said elements is an integer multiple of the other element.

18) Articles of claim 2, said nanoparticles are a chemical compound,

19) Articles of claim 18, said chemical compound is either from the group including: polymeric materials, bioceramics, liposomes, polyethylene glycol, and dendrimers.

20) Articles of claim 18, said chemical compound is a functionalized surface coating.
